(19) United States
(12) Patent Application Publication
(10) Pub. No.: US 2010/0193743 A1
(43) Pub. Date: Aug. 5, 2010

(54) Gasification

(75) Inventor: George Willacy, Chester (GB)

Correspondence Address: Larson & Anderson, LLC, P.O. BOX 4928, DILLON, CO, 80435, US

(73) Assignee: REFGAS LIMITED, Flintshire Clwyd (GB)

(21) Appl. No.: 12/679,949

(22) PCT Filed: Sep. 22, 2008
(86) PCT No.: PCT/GB08/50847

§ 371 Date: Mar. 25, 2010

(30) Foreign Application Priority Data
Sep. 25, 2007 (GB) 0718663.8

(51) Int. Cl. C01B 3/32; B01J 19/18

(52) U.S. Cl. 252/373; 422/149

(57) ABSTRACT

In the gasification process, shredded municipal waste is allowed to descend through a pyrolysis reactor and the waste is pyrolysed in the reactor to form a combustible gas. The waste is contacted in a downdraft with an air supply which has been preheated by heat exchange with the pyrolysis reactor and further heated by heat exchange with combustible exhaust gas from the pyrolysis reactor.

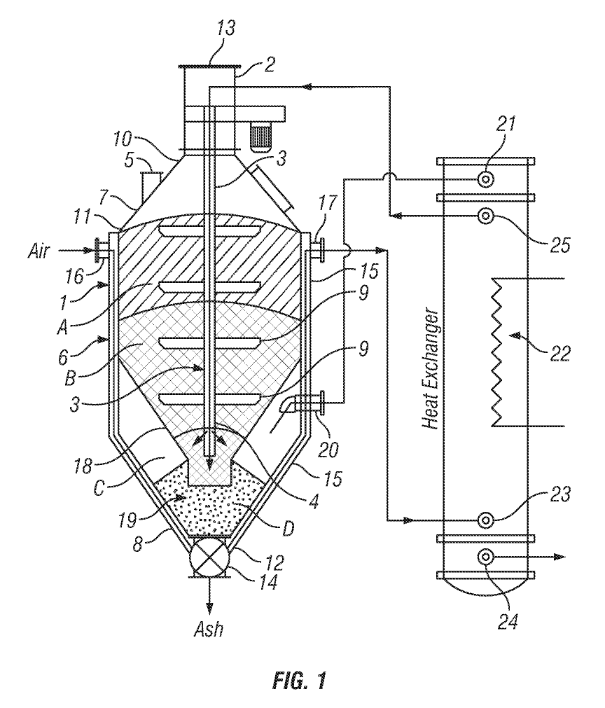

The present invention relates to gasification, and apparatus for use therewith, and in particular a gasification apparatus and process for producing combustible gas from biomass waste material, and especially from waste material known as refuse derived fuel.

Refuse-derived fuel (RDF), which is generally produced by shredding municipal solid waste, consists largely of organic components of municipal waste such as plastics and biodegradable waste. Non-combustible materials such as glass and metals are removed mechanically and the resultant material compressed into pellets, bricks, or logs and used for conversion to combustible gas, which can itself be used for electricity generation or the like..

It has recently been proposed (for example, in WO 2007/081296 A1), to use unsorted RDF in a gasification process (for use in the water gas shift reaction). Such a process is however, difficult to control sufficiently to ensure feedstock distribution, aeration and to avoid bridging the reactor. WO 2007/081296 A1 indicates that there are generally three types of gasification process, namely updraft (in which heated air is fed upwards through the pyrolysis zone and the fuel is allowed to descend through the pyrolysis zone), downdraft (or co-flow) in which heated air and fuel enter the reaction zone from the top of the reactor and descend together through the pyrolysis zone, or fluidised bed, in which the fuel is suspended on (typically) steam, and allowed to pyrolyse by contact with heated air.

It is an object of the present invention to provide an improved downdraft gasification process and apparatus therefor.

According to the invention, there is provided a downdraft gasification process in which shredded municipal waste is allowed to descend through a pyrolysis reactor and the waste is pyrolysed in the reactor to form a combustible gas, wherein the waste is contacted in the pyrolysis reactor in a downdraft with air which has been preheated successively by heat exchange with the pyrolysis reactor and by heat exchange with exhaust gas from the pyrolysis reactor.

The process according to the invention permits the use of a reactor, which will take loose shredded feedstock with higher moisture content; this has a major impact on cost and efficiency. Pelletising the waste (which is a requirement for most conventional downdraft gasifier systems) is expensive due to the high capital cost of equipment and the large amounts of energy used in the process; these costs can therefore be avoided according to the invention. In a gasifier accepting about 30,000 tonnes of waste per annum, this can represent a saving of about £150,000 per annum at current rates.

Conventional pelletisers have high maintenance demands and have reliability issues; pelletising cannot be carried out on a feedstock with moisture content above 15%. This is difficult to achieve without pre-drying which, again, would involve a high capital cost and high energy use costs, along with mechanical reliability problems; these costs and problems can be alleviated according to the invention.

The present invention further comprises gasification apparatus for pyrolysing shredded municipal waste, which apparatus comprises a reactor having a pyrolysis zone in which the waste is allowed to descend through the pyrolysis zone, an air supply for the pyrolysis zone such that the air passes through the pyrolysis zone in downdraft, means permitting pre-heating of the air supply by the pyrolysis zone, and heat exchange means for further heating pre-heated air supply with exhaust gas from the pyrolysis zone.

In a preferred embodiment of the invention, a high temperature mixer system is employed with a central or axial hollow shaft, which allows air to be directed into the oxidation zone resulting in more even heat distribution and improved combustible gas quality which has smaller quantities of tars.

According to the invention, air can be passed around the outer wall of a pyrolysis reactor so as to cool the outer wall and pre-heat the air (typically to about 100° C.).

The preheated air can then pass through a large capacity heat exchanger that cools hot combustible gas exiting from the pyrolysis reactor (typically from about 500° C. to about 100° C.) while at the same time heating the preheated air, typically from about 100° C. to about 400° C.

The preheated air and the combustible gas exiting from the pyrolysis reactor are preferably supplied in countercurrent to one another, typically with the preheated air rising through the heat exchanger while the combustible gas descends through the reactor.

It is known to use chillers to cool the gas; this results in loss of heat and energy. In contrast, pre-heating the air according to the invention to about 400° C. can greatly improve the efficiency of the gasification process and allow introduction of unpelletised feedstock at up to 30% moisture. The high moisture content can be turned into superheated steam because of the high temperatures in the reactor, thereby improving gas quality in the water gas reaction.

A preferred embodiment of the present invention will now be described, with reference to the accompanying drawing, which is a schematic cross-section of an exemplary gasifier suitable for use in a process according to the invention.

Referring to the drawing, there is shown a vertically oriented gasifying reactor 1 having an inlet 2 for air at its upper end. The air is channelled from the inlet 2 through an axial shaft 3 having an open lower end 4.

Also at the upper end of the reactor is a hopper inlet 5 for fuel, into which refuse-derived fuel is allowed to feed (for example, being fed to the funnel inlet 5 by means of a conveyor or the like—not shown).

The reactor 1 as shown has a median zone 6 of substantially cylindrical shape, an upper tapered throat portion 7 in which the hopper inlet 5 is located, and a tapered bottom portion 8. The shaft 3 is coaxial with the axis of the reactor, and has a series of paddles or blades 9 secured thereto; the shaft can be driven so as to cause the blades to agitate solids present in the median zone 6.

The upper tapered throat portion 7 tapers outwardly from an apex 10 towards the top 11 of the median zone 6. The tapered bottom portion 8 tapers inwardly from the bottom of the median zone 6 towards a base 12. Top 11 is provided with a flue 13, and base 12 is provided with a rotary valve 14 permitting egress of ash from the reactor 1. Valve 14 typically has an airlock screw auger system (not shown) for discharge of inert ash from the heat-generating combustion process.

The outer walls of the median zone 6 and of the tapered bottom portion 8 have an air passageway 15 arranged for heat exchange with the walls; the passageway has an inlet 16 for cool air near the top of the median zone, and an outlet 17 for pre-warmed air also near the top of the median zone, but diametrically spaced from inlet 16. Air entering inlet 16 (typically at about ambient temperature, or about 20° C.) passes around the periphery of the median zone 6, and exits from outlet 17 after having been warmed to a temperature of typically about 100° C.

Within the median zone 6 is an axially oriented funnel member 18 tapering inwardly from the inner walls of the median zone 6 to a constricted funnel outlet 19 within the tapered bottom portion.

In an outer wall of the median zone 6 is a hot gas outlet 20, for permitting hot combustible gas from the median zone to exit. As shown, hot combustible gas is directed from the hot gas outlet 20 to an inlet 21 of a heat exchanger 22. In the heat exchanger 22 the hot combustible gas is allowed to flow in heat exchange contact with warmed air from outlet 17 of the reactor 1, which enters the heat exchanger 22 via an inlet 23. The hot combustible gas is thereby cooled to about 100° C. in the heat exchanger (and allowed to exit via a port 24), while the air is heated by the hot combustible gas (typically to a temperature of about 400° C.), and recirculated from a port 25 to the inlet 2.

Solids entering hopper inlet 5 are allowed to fall slowly through the median zone 6; there are effectively three reaction zones for the solids within the median zone.

The first of these is a drying zone A, towards the top of median zone (in which drying zone the temperature of the solids is raised to above 200° C. and water and other volatiles are driven off). Hot air from this zone, together with steam produced in the drying zone (because of the evaporation of fuel moisture in the drying zone) is passed to a pyrolysis zone B.

In the pyrolysis zone B, the temperature of the solids in the median zone is raised to above 500° C.

The solids then descend to an oxidation zone C, in the constricted throat above the funnel outlet 19, in which oxidation of the solids takes place.

The paddles or blades 9 provided on the shaft 3, which is rotatable such that the blades or panels can effect mixing in the pyrolysis zone in order to prevent fuel bridging and channelling inside the reactor.

In the arrangement shown, air entering the passageway via inlet 16, is typically pre-heated to about 100° C., while cooling the reactor wall. The air temperature is then boosted to about 400° C. in the heat exchanger 21 by gas from the reactor. The gas leaving the heat exchanger 21 is therefore cooled to about 100° C., and is cooled further ready for use in engine combustion.

Within the median zone, the mixing mechanism incorporating the blades or panels and the shaft help to distribute the feed evenly and helps to prevent bridging. The hollow mixer shaft allows hot air to give even air distribution directly into the oxidation zone.

A higher moisture content and the introduction of hot air increases superheating of steam to improve the water gas reaction, which therefore reduces tar and increases hydrogen production (that is, produces gas of higher calorific value gas).

Within the reactor are (from the top downwards) a respective drying zone A, in which the feedstock is typically heated to about 200° C., a pyrolysis zone B in which the feedstock is typically further heated to about 500° C., an oxidation zone C in which temperatures of typically about 1000° C. are achieved, and a water shift reaction zone D towards the base of the reactor.

The process and apparatus according to the invention can permit inhomogeneous waste to be converted into a homogenous combustible gas, in a continuous operation.

The process according to the invention preferably employs a mixer device with an air supply shaft within the reactor.

The process according to the invention permits direct use of municipal waste without densification, and the product gas may, without cleaning, be used for gas-fired steam boilers combined with steam turbines or for increased steam superheating.

After gas cooling and clean-up; the product gas may even be used for direct firing of gas turbines and gas engines and in some cases for powering high temperature fuel cells.

The present invention further comprises combustible gas for use in energy generation, the gas being produced by a process according to the invention, or in apparatus according to the invention.

1-9. (canceled)

10. A downdraft gasification process which comprises
(a) providing a feedstock comprising shredded municipal waste;
(b) allowing said feedstock to descend through a pyrolysis reactor having an oxidation zone and a pyrolysis zone;
(c) supplying heated air to said pyrolysis zone;
(d) feeding said heated air in downdraft, together with said feedstock waste, downwards through said pyrolysis reactor under conditions selected and controlled to cause pyrolysis of said feedstock in said pyrolysis zone to thereby form a hot combustible gas; and
(e) allowing said hot combustible gas to exit from the pyrolysis reactor as a hot exhaust gas; and
(f) preheating said air supply to said pyrolysis reactor by heat exchange successively with said pyrolysis reactor and with said hot exhaust gas.

11. The process according to claim 10, wherein the feestock is in loose shredded unpelletized form.

12. The process according to claim 10, in which the reactor includes a high temperature mixer system having a central hollow shaft, and in which said heated air is directed via said hollow shaft to said oxidation zone.

13. The process according to claim 10, wherein said preheating in step (f) is by passing the air supply around an outer wall of the pyrolysis reactor so as to cool said outer wall.

14. The process according to claim 13, wherein the preheated air supply from step (f) is further heated by passing through a heat exchanger in countercurrent to said exhaust gas.

15. The process according to claim 10, wherein the preheated air supply from step (f) is further heated by passing through a heat exchanger in countercurrent to said exhaust gas.

16. Gasification apparatus for pyrolyzing shredded municipal waste, which apparatus comprises:
(a) a reactor having an oxidation zone and a pyrolysis zone, in which said waste is allowed to descend through the pyrolysis zone, and to thereby produce a combustible exhaust gas which exhaust gas is allowed to exit the reactor above the pyrolysis zone,
(b) an air supply for said pyrolysis zone which permits said air to pass through said pyrolysis zone in downdraft,
(c) a first heat exchanger for pre-heating of said air supply by said pyrolysis zone, and
(d) a second heat exchanger for further heating said pre-heated air supply with exhaust gas from said pyrolysis zone.

17. The apparatus according to claim 16, in which said first heat exchanger includes an air channel, said air channel being in thermal contact with an outer wall of the reactor so as to permit pre-heating of said air supply.

18. The apparatus according to claim 16, which further comprises a high temperature mixer having a central or axial hollow shaft, which allows the air supply to be directed into an oxidation zone of the pyrolysis reactor.
